(19) United States
(12) Patent Application Publication
(10) Pub. No.: US 2013/0128607 A1
(43) Pub. Date: May 23, 2013

(54) Methods, Systems, and Products for Illuminating Displays

(71) Applicant: Kevin A. Li, Chatham, NJ (US)

(72) Inventor: Kevin A. Li, Chatham, NJ (US)

(73) Assignee: AT&T INTELLECTUAL PROPERTY I, L.P., Atlanta, GA (US)

(21) Appl. No.: 13/298,519

(22) Filed: Nov. 17, 2011

(51) Int. Cl. F21V 8/00

(52) U.S. Cl. 362/603

(57) ABSTRACT

Methods, systems, and products illuminate display devices. Light is injected into a tapered portion of a waveguide. The tapered portion reflects the light to create total internal reflectance in the waveguide. The light in the waveguide is frustrated and frustrated light is directed onto an array of picture elements. The frustrated light illuminates the array of picture elements.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

Electronic displays are commonly used as output devices. Flat-panel displays, for example, are used in computers, cell phones, and entertainment systems to display movies, pictures, and other content. Conventional electronic displays, though, are back lit. That is, conventional electronic displays are illuminated from behind.

### BRIEF DESCRIPTION OF THE SEVERAL VIEWS OF THE DRAWINGS

The features, aspects, and advantages of the exemplary embodiments are better understood when the following Detailed Description is read with reference to the accompanying drawings, wherein:

FIG. 1 is a simplified sectional view of an illuminated display device, according to exemplary embodiments;

FIGS. 2-4 are more sectional views of the illuminated display device, according to exemplary embodiments;

FIGS. 5-6 are top views of the illuminated display device, according to exemplary embodiments;

FIGS. 7-8 are more sectional views of the illuminated display device, according to exemplary embodiments;

FIG. 9 is a partial sectional view illustrating encasement of light, according to exemplary embodiments;

FIG. 10 is a block diagram illustrating the illuminated display device, according to exemplary embodiments;

FIG. 11 is another sectional view of the illuminated display device, according to exemplary embodiments;

FIG. 12 is a top view of the illuminated display device, according to exemplary embodiments;

FIGS. 13-15 are schematics illustrating magnification, according to exemplary embodiments;

FIG. 16 is an exploded view of a computing device incorporating the exemplary embodiments;

FIG. 17 is an exploded view of an instrument cluster incorporating the exemplary embodiments; and

FIG. 18 is another partial sectional view illustrating radii of curvature, according to exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

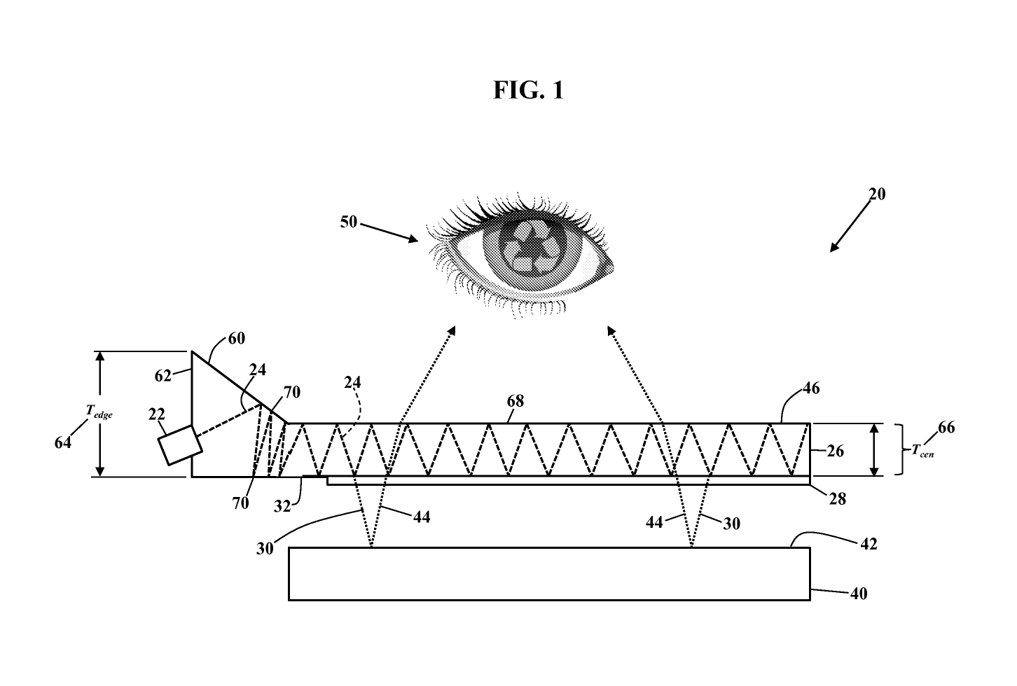

FIG. 1 is a simplified sectional view of an illuminated display device 20, according to exemplary embodiments. A light source 22 injects or emits light 24 into a waveguide 26. The light 24 may be injected at an angle such that total internal reflection (or “TIR”) is obtained. Because the injected light 24 is totally internally reflected within the waveguide 26, a frustator 28 may cause frustrated light 30 to exit a bottom surface 32 of the waveguide 26. The frustrated light 30 is directed downward and onto electronic picture elements (or “pixels”). The picture elements are commonly arranged in a two-dimensional grid forming an array 40 of picture elements, as in liquid crystal, plasma, and digital light projector (or “DLP”) displays. Because the waveguide 26 is arranged above the array 40 of picture elements, the frustrated light 30 is incident an upper surface 42, thus illuminating the array 40 of picture elements from above. Reflected light 44 reflects off the upper surface 42 of the array 40 of picture elements and travels back into the waveguide 26. The reflected light 44 propagates through the waveguide 26 and exits an outer surface 46 of the waveguide 26. The reflected light 44 thus presents to a viewer's eye 50 an image created by the array 40 of picture elements. FIG. 1 thus illustrates a top-lit arrangement in which the array 40 of picture elements is illuminated from above.

As FIG. 1 illustrates, the waveguide 26 has a tapered cross-section 60. That is, an outer edge 62 of the waveguide 26 may have a greater cross-sectional thickness T_{edge} (illustrated as reference numeral 64) than a cross-sectional thickness T_{cen} (illustrated as reference numeral 66) of a thinner central region 68 of the waveguide 26. The tapered cross-section 60 internally reflects and focuses the light 24 injected or emitted from the light source 22. As incident light 24 encounters an angled surface 70 in the tapered cross-section 60, the light 24 reflects such that an angle of incidence is equal to an angle of reflection, according to the Snell's law of reflection. The tapered cross-section 60 may thus have a wedge shape with one or more of the angled surfaces 70. Each angled surface 70 further reflects a path of the light 24 within the tapered cross-section 60. The light 24 is thus focused and injected at an angle such that total internal reflection (or “TIR”) is obtained within the central region 68 of the waveguide 26.

FIG. 1 thus illustrates illumination using frustrated total internal reflection (or “FTIR”). FIG. 1, though, uses frustrated total internal reflection to illuminate the array 40 of picture elements from above. Exemplary embodiments thus position, arrange, or place the waveguide 26 between the array 40 of picture elements and the viewer's eye 50. That is, the frustrated light 30 (that exits the waveguide 26) illuminates the upper surface 42 of the array 40 of picture elements. The reflected light 44 propagates back through the waveguide 26, exits the outer surface 46 of the waveguide 26, and travels to the viewer's eye 50. The total internal reflection and the frustrated total internal reflection are well known physical and optical phenomena to those of ordinary skill in the art. This disclosure, then, need not further explain either phenomena.

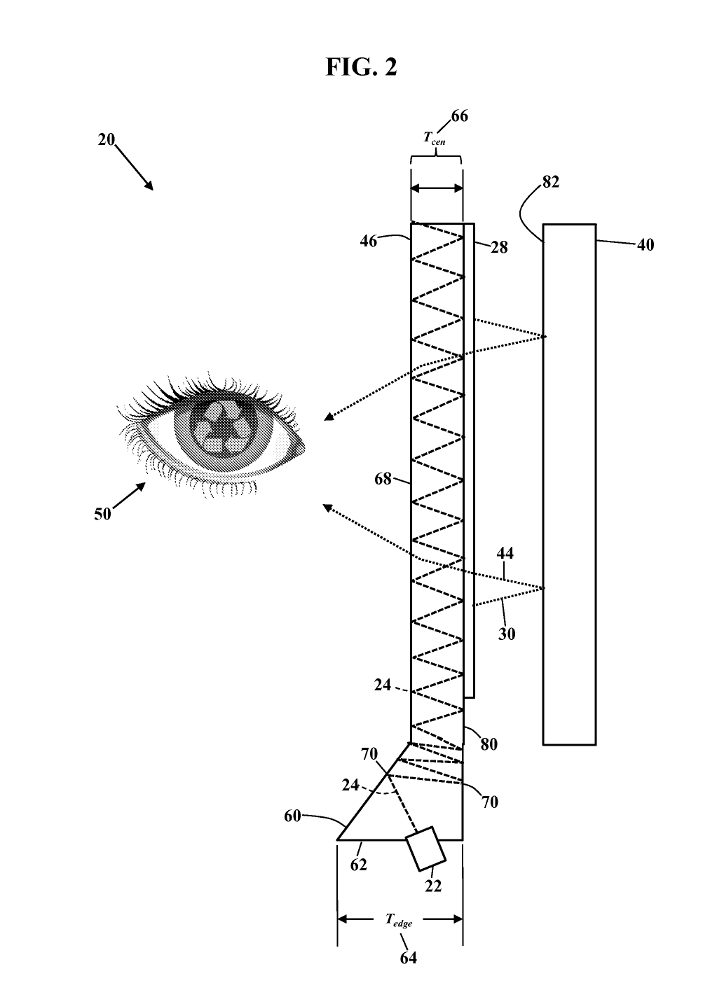

FIG. 2 is another sectional view of the illuminated display device 20, according to exemplary embodiments. Here, though, the terminology is changed to illustrate a front-lit orientation. The light 24 is injected into the tapered cross-section 60 of the waveguide 26. The light 24 is reflected by the one or more of the angled surfaces 70, such that the light 24 is focused to create total internal reflectance in the central region 68 of the waveguide 26. The frustator 28 is placed or applied to an inner (or right) surface 80 of the waveguide 26, thus causing the frustrated light 30 to exit the inner surface 80. The frustrated light 30 illuminates an outward surface 82 of the array 40 of picture elements. Reflected light 44 reflects off the array 40 of picture elements and travels back into the waveguide 26. The reflected light 44 propagates through the waveguide 26, exits the outer surface 46 of the waveguide 26, and travels to the viewer's eye 50.

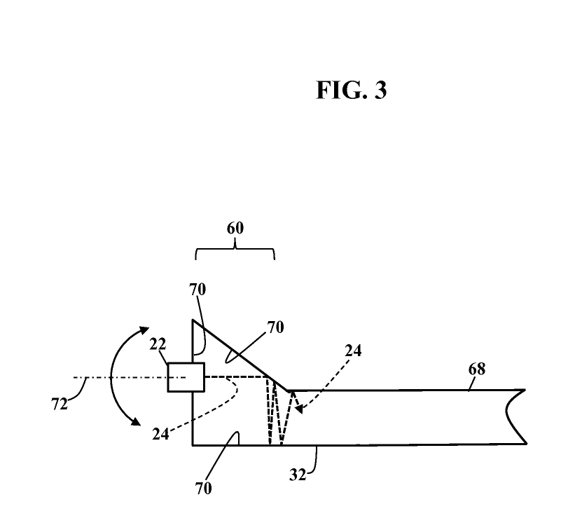

FIG. 3 is a partial sectional view of the illuminated display device 20, according to exemplary embodiments. Here the light source 22 may have any orientation to inject or emit the light 24 into the waveguide 26. The light 24 may be injected at any angle with respect to the edge 62 of the waveguide 26, with respect to the tapered cross-section 60, and/or with respect to the central region 68 of the waveguide 26. Indeed, the light source 22 may be adjustable along a central axis 72 to change a direction of injection of the light 24. However the light source 22 is oriented, the light 24 reflects at one or more of the angled surfaces 70 in the tapered cross-section 60 such that total internal reflection (or “TIR”) is obtained within the central region 68 of the waveguide 26.

The light source 22 efficiently injects the light 24. The light source 22 is configured to reduce loss of the light 24. The light source 22, for example, may be a light emitting diode (“LED”) that injects the light 24 into the outer edge 62 of the waveguide 26. The light source 22 may be attached to the outer edge 62 of the waveguide 26, perhaps using an adhesive adherent (such as cyanoacrylate) to attach an LED to the waveguide 26. The light source 22, however, may be secured to any of the angled surfaces 70 in the tapered cross-section 60 using a mechanical fastener, such as a screw, snap-fit connector, or slotted channel. The light source 22 may also be molded, cast, or embedded into the tapered cross-section 60 of the waveguide 26. Cyanoacrylate may be used as a coupler to improve transmission efficiency of a junction between the light source 22 and the outer edge 62 and/or the tapered cross-section 60 of the waveguide 26.

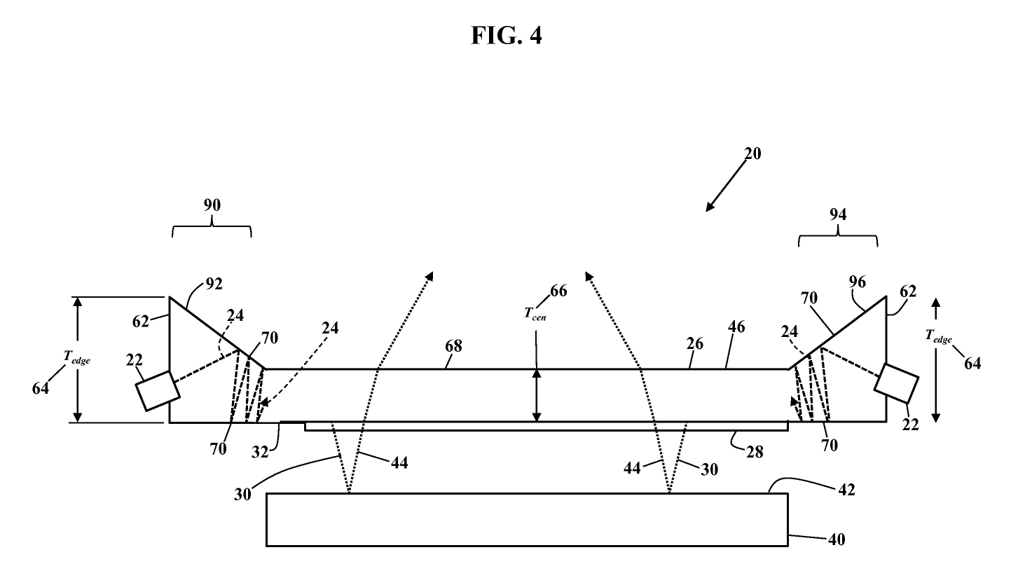

FIG. 4 is another sectional view of the illuminated display device 20, according to exemplary embodiments. Here, though, the tapered cross-section 60 may be fabricated at opposite edges of the waveguide 26. That is, a left region 90 of the waveguide 26 may have a left tapered cross-section 92, while a right region 94 of the waveguide 26 may have a right tapered cross-section 96. Each tapered cross-section 92 and 96 may have its own light source 22 (such as light emitting diodes). Each tapered cross-section 92 and 96 may have the greater cross-sectional thickness T_{edge} than the cross-sectional thickness T_{cen} of the thinner central region 68 of the waveguide 26. The light 24 is injected into the tapered cross-sections 92 and 96. Each respective tapered cross-section 92 and 96 internally reflects the light 24 at the one or more angled surfaces 70. Each respective tapered cross-section 92 and 96 focuses the light 24 for injection at an angle such that total internal reflection (or “TIR”) is obtained within the central region 68 of the waveguide 26. The frustator 28 causes the frustrated light 30 to exit the inner surface 80 and illuminate the outward surface 82 of the array 40 of picture elements. The reflected light 44 reflects off the array 40 of picture elements and travels back into the waveguide 26. The reflected light 44 propagates through the waveguide 26 and exits the outer surface 46 of the waveguide 26.

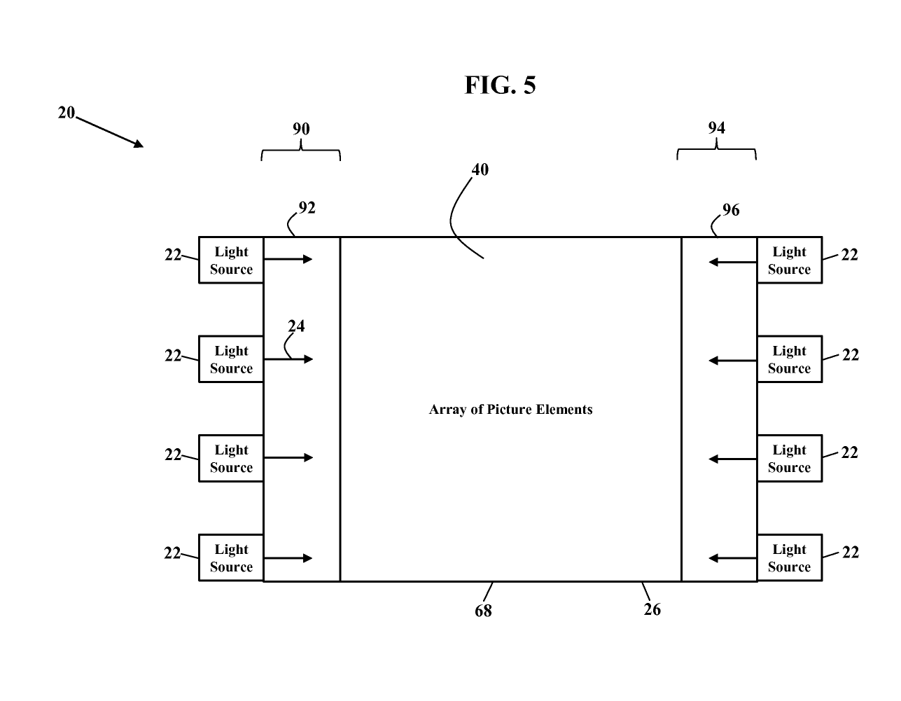

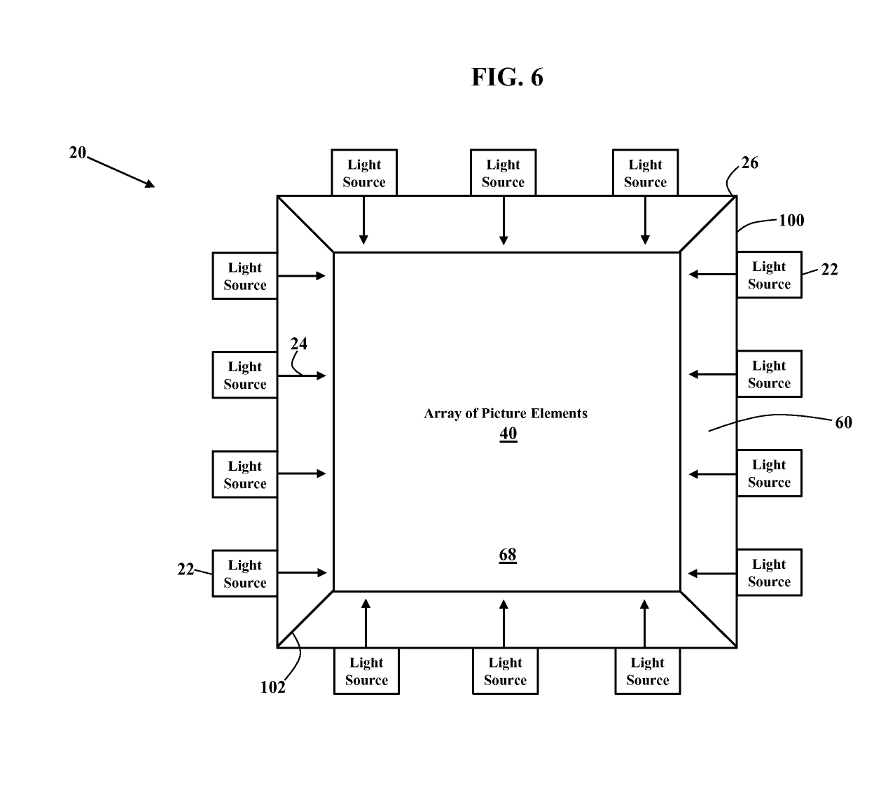

FIGS. 5-6 are top views of the illuminated display device 20, according to exemplary embodiments. FIG. 5 illustrates opposite edges of the waveguide 26 focusing the light 24 into the central region 68. FIG. 5 illustrates the left region 90 of the waveguide 26 having the left tapered cross-section 92, while FIG. 5 illustrates the right region 94 of the waveguide 26 having the right tapered cross-section 96. Multiple light sources 22 may inject the light 24 into each tapered cross-section 92 and 96. The light 24 reflects within the tapered cross-sections 92 and 96 for focused injection at an angle such that total internal reflection (or “TIR”) is obtained within the central region 68 of the waveguide 26. The light 24 may then be frustrated for illuminating the array 40 of picture elements (as earlier paragraphs explained).

FIG. 6 illustrates multiple-sided injection. Here multiple outer edges 100 of the waveguide 26 may include the tapered cross-section 60. One or multiple light sources 22 at each outer edge 100 inject the light 24 into each tapered cross-section 60. The light 24 reflects within each tapered cross-section 60 for focused injection at an angle such that total internal reflection (or “TIR”) is obtained within the central region 68 of the waveguide 26. The light 24 may then be frustrated for illuminating the array 40 of picture elements (as earlier paragraphs explained). FIG. 6 illustrates the tapered cross-section 60 at each outer edge 100 of the waveguide 26. That is, each side of the illuminated display device 20 may be constructed to include the tapered cross-section 60. The illuminated display device 20, however, may be constructed such that one or more sides do not have the tapered cross-section 60 for focusing the light 24. Moreover, the tapered cross-section 60 may be adapted to suit any design of the illuminated display device 20 having any number of sides (e.g., triangle, pentagon, octagon, or irregular).

FIG. 6 also illustrates beveling of mating edges. When adjacent sides include the tapered cross-section 60, a joint 102 mates adjoining tapered cross-sections 60. The joint 102 may be mitered and/or beveled, according to the cross-sectional thickness T_{edge} of each tapered cross-sections 60.

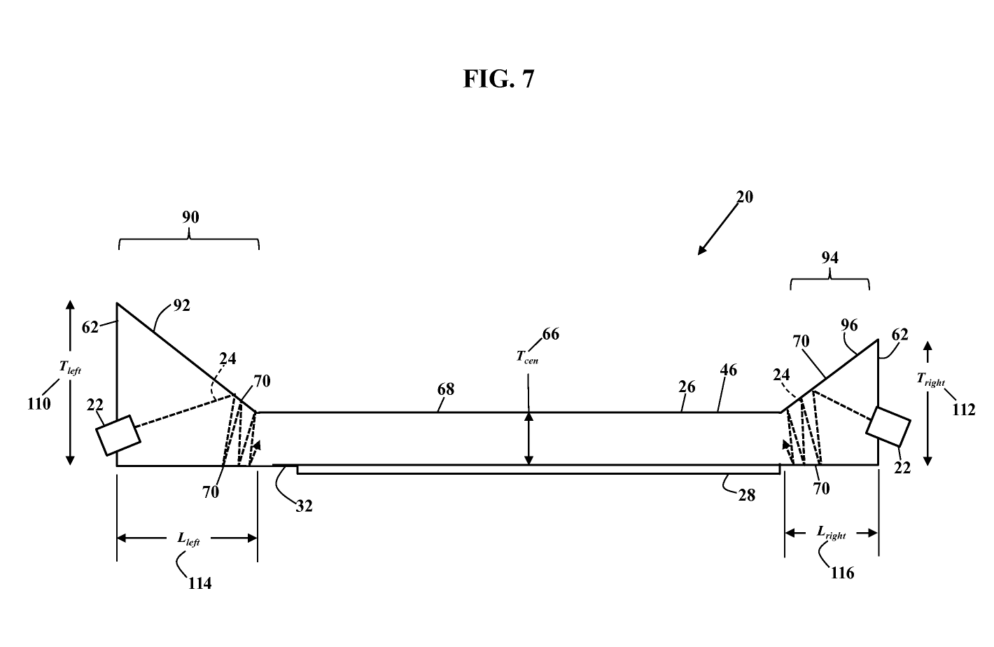

FIG. 7 is another sectional view of the illuminated display device 20, according to exemplary embodiments. Here, though, the tapered cross-sections may have different cross-sectional areas, depending on design criteria and/or the optical properties desired in the waveguide 26. As FIG. 7 illustrates, the left tapered cross-section 92 may have a greater cross-sectional thickness T_{left} (illustrated as reference numeral 110) than a cross-sectional thickness T_{right} (illustrated as reference numeral 112) of the right tapered cross-section 96. The left tapered cross-section 92 may, likewise, have a greater or longer cross-sectional length L_{left} (illustrated as reference numeral 114) than a cross-sectional length L_{right} (illustrated as reference numeral 116) of the right tapered cross-section 96. The thicknesses and lengths of the tapered cross-sections 92 and 96 may be unequal to achieve different focusing objectives.

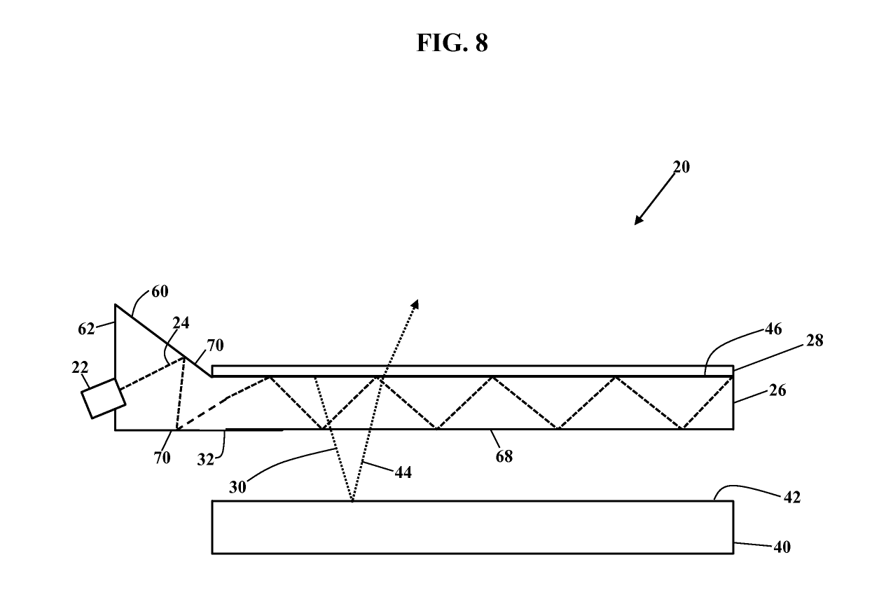

FIG. 8 is another sectional view of the illuminated display device 20, according to exemplary embodiments. Here the frustrator 28 is placed or applied to the outer surface 46 of the waveguide 26. The light 24 is injected into the tapered cross-section 60 and reflected to create total internal reflection within the central region 68 of the waveguide 26. Because the frustrator 28 is placed or applied to the outer surface 46 of the waveguide 26, the frustrated light 30 also enters and propagates through the central region 68 of the waveguide 26. The frustrated light 30 exits the bottom surface 32 of the waveguide 26 and illuminates the upper surface 42 of the array 40 of picture elements. The reflected light 44 propagates back through the waveguide 26 and exits the outer surface 46 of the waveguide 26. FIG. 8 thus illustrates that the frustrator 28 may be placed on either the bottom surface 32 or the outer surface 46 of the waveguide 26, according to exemplary embodiments.

FIGS. 1-8 thus illustrate incoming light and reflected light. The incoming light 24 propagates into and through the waveguide 26. The incoming light 24 is directed from the waveguide 26 and onto the array 40 of picture elements. The incoming light 24 reflects from the array 40 of picture elements and back into the waveguide 26, thus creating the reflected light 44. The incoming light 24 may travel in a first direction, and the reflected light 44 may travel in a second direction. The incoming light 24 and the reflected light 44 may even travel in opposite directions, such as when the incoming light 24 is normally incident to upper surface 42 of the array 40 of picture elements.

The light source(s) 22 may inject light of any wavelength. Each light source 22, for example, may inject visible light into the tapered cross-section 60 of the waveguide 26. The visible light may be of any frequency in the electromagnetic spectrum that is perceivable by the human eye 50. Any light source 22 may emit or inject monochromatic light (such as red or blue light). Any light source 22 may even be variable, thus permitting a human or software program to select colors of illumination. The light source 22, however, may also inject ultraviolet, infrared, and any other non-visible wavelengths in the electromagnetic spectrum. The light source 22 may be light emitting diodes. Each light source 22 may be a single light emitting diode or a bank or series of light emitting diodes. If cost and design permit, the light source 22 may be a string of light emitting diodes that are arranged around at least a portion of an edge perimeter of the array 40 of picture elements. The light source 22, however, may utilize incandescent elements.

The frustator 28 may be of any design. The frustrator 28, for example, may be any metallic cladding applied to the inner (or right) surface 32 or 60 of the waveguide 26, thus causing the frustrated light 30 to locally exit the waveguide 26. The frustrator 28, however, may be any non-metallic coating applied to the waveguide 26. The frustrator 28, for example, may be any polymeric or elastomeric thin film, sheet, or material that is applied or adhered to the waveguide 26. The frustator 28, in other words, may be any transparent or semi-transparent material that extracts the frustrated light 30 from the waveguide 26.

The waveguide 26 may also be of any shape and design. The waveguide 26 generally has a planar cross-section, although opposite surfaces and/or sides need not be parallel. The bottom surface 32 of the waveguide 26 and the outer surface 46 of the waveguide 26, for example, may be parallel. The bottom surface 32 and the outer surface 46, however, may not be parallel, thus having a wedge-shaped cross-section. Moreover, the waveguide 26 may have any number of edges or sides. The waveguide 26, for example, may have a rectangular top or plan view, thus having four (4) edges or sides. The waveguide 26, however, may have a triangular shape (e.g., three sides or edges) when viewed from above (plan view). The waveguide 26, however, may have more than four edges, such as a pentagonal or hexagonal shape when viewed from above. The waveguide 26 may also be constructed or formed of any material, such as glass, polymer, and/or acrylic. The waveguide 26 may also be transparent or even semi-transparent that transmits the reflected light 44.

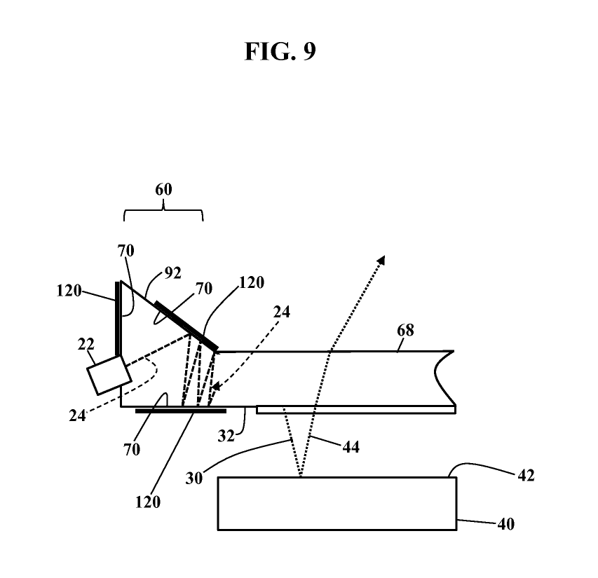

FIG. 9 is a partial sectional view illustrating encasement of the light 24, according to exemplary embodiments. Here the tapered cross-section(s) 60 (or 92 and/or 96) may be manipulated to encase or retain the light 24. Because the tapered cross-section(s) 60, 92, and/or 96 reflect and focus the light 24 for total internal reflection, the tapered cross-section(s) may further have features for reducing, or even preventing, refraction of the light 24. As the light 24 encounters the angled surface(s) 70, some light 24 may refract at a boundary interface. That is, some of the incident light 24 may reflect and some of the incident light 24 may transmit through the tapered cross-section and into another medium (e.g., air or argon). Because total internal reflection is desired, any of the angled surface(s) 70 may have an encasement feature 120. The encasement feature 120 ensures the light 24 reflects with minimal or no refracting. The encasement feature 120, for example, may be any metallic or non-metallic coating or cladding that causes the light 24 to completely, or nearly completely, reflect at any angled surface 70 within the tapered cross-section 60 (or 92 and/or 96). The encasement feature 120 may be applied to an inner surface within the tapered cross-section, and/or the encasement feature 120 may be applied to an outer surface. The encasement feature 120 may be embedded within a wall thickness of the tapered cross-section, such as reflective particles. The encasement feature 120 may be a reflective foil or film that is applied to, or deposited onto, an inner or outer surface of the tapered cross-section. The encasement feature 120 may also be a physical reflector, although a reflector is less optically efficient (as refraction has occurred). The encasement feature 120 may entirely or partially extend, or be applied, along an entire length of the angled surface 70. Regardless, the encasement feature 120 ensures the light 24 reflects with minimal or no refracting.

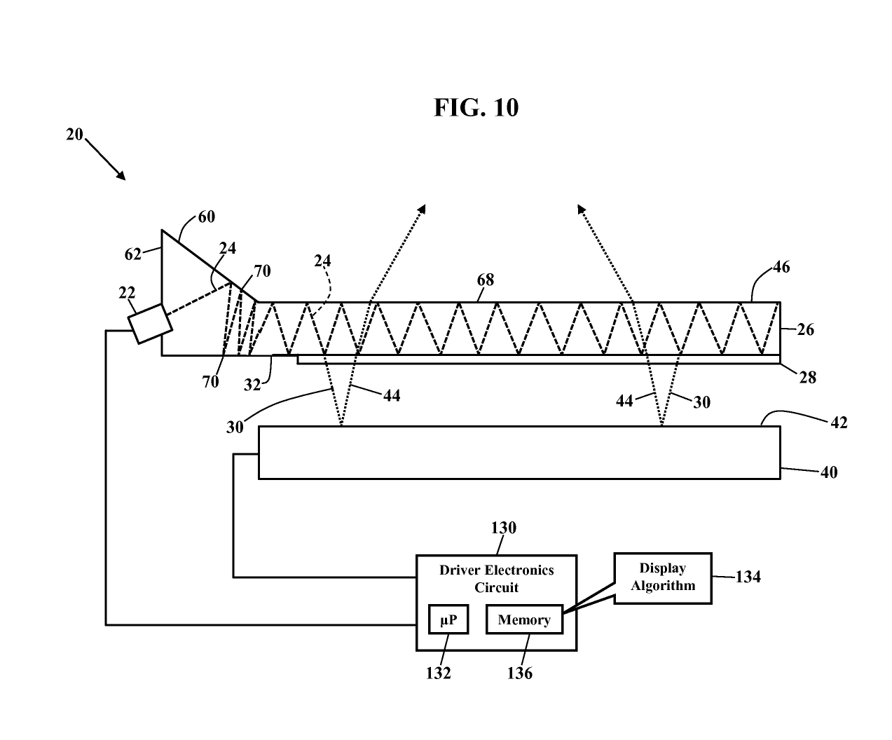

FIG. 10 is a block diagram illustrating the illuminated display device 20, according to exemplary embodiments. Here the display device 20 may include a driver electronics circuit 130. Each picture element (or “pixel”) in the array 40 of picture elements may be individually switched on and off by the driver electronics circuit 130. A processor 132 (e.g., “μP”), application specific integrated circuit (ASIC), or other component may execute a display algorithm 134 stored in a memory 136. The display algorithm 134 includes code or instructions may cause the processor 132 to control the driver electronics circuit 130, the array 40 of picture elements, and/or the light source 22. The driver electronics circuit 130 may apply a voltage to electrically activate any picture element in the array 40 of picture elements to produce any image. The driver electronics circuit 130, the processor 132, and the display algorithm 134 may cooperate to control the array 40 of picture elements and/or to create an image by the array 40 of picture elements. The display algorithm 134 may even cause the processor 132 to produce sounds and other audible features.

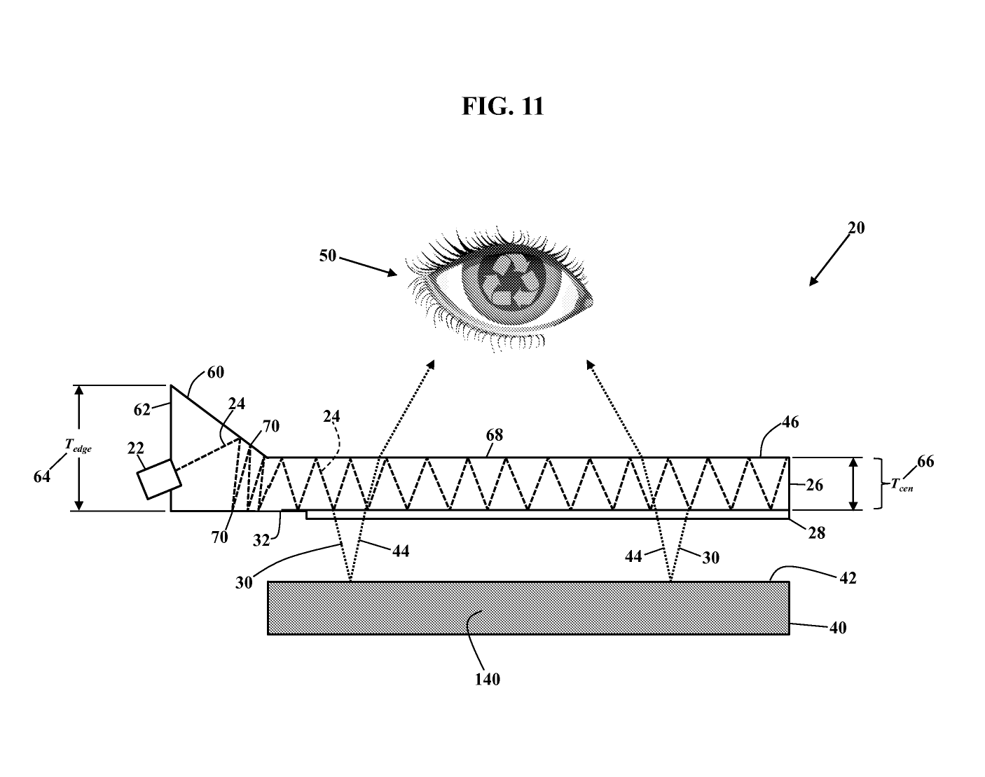

FIG. 11 is another sectional view of the illuminated display device 20, according to exemplary embodiments. Here the array 40 of picture elements may be opaque 140, thus mostly or substantially preventing light from passing or propagating through the array 40 of picture elements. Conventional displays utilize transparent picture elements, thus allowing the picture elements to be illuminated from behind or below. When the picture elements are opaque, as in electronic ink devices, light cannot propagate through opaque picture elements. Because exemplary embodiments arrange the array 40 of picture elements below or behind the waveguide 26, exemplary embodiments may illuminate opaque picture elements.

As FIG. 11 illustrates, the light source 22 injects the light 24 into the tapered cross-section 60 of the waveguide 26. The light 24 reflects within the tapered cross-section 60 for focused injection at an angle such that the total internal reflection (or “TIR”) is obtained within the central region 68 of the waveguide 26. The light 24 may then be frustrated for illuminating the array 40 of picture elements (as earlier paragraphs explained). The frustator 28 causes the frustrated light 30 to exit the inner surface 32 of the waveguide 26. The frustrated light 30 illuminates the outward surface 42 of the array 40 of picture elements. Even if the individual picture elements (in the array 40 of picture elements) are opaque, the reflected light 44 still reflects back into the waveguide 26. The reflected light 44 propagates through the waveguide 26, exits the outer surface 46 of the waveguide 26, and travels to the viewer's eye 50. FIG. 11 thus illustrates that exemplary embodiments may be used with both transparent and/or opaque picture elements. Exemplary embodiments, in other words, may illuminate any type of picture element, whether transparent or opaque.

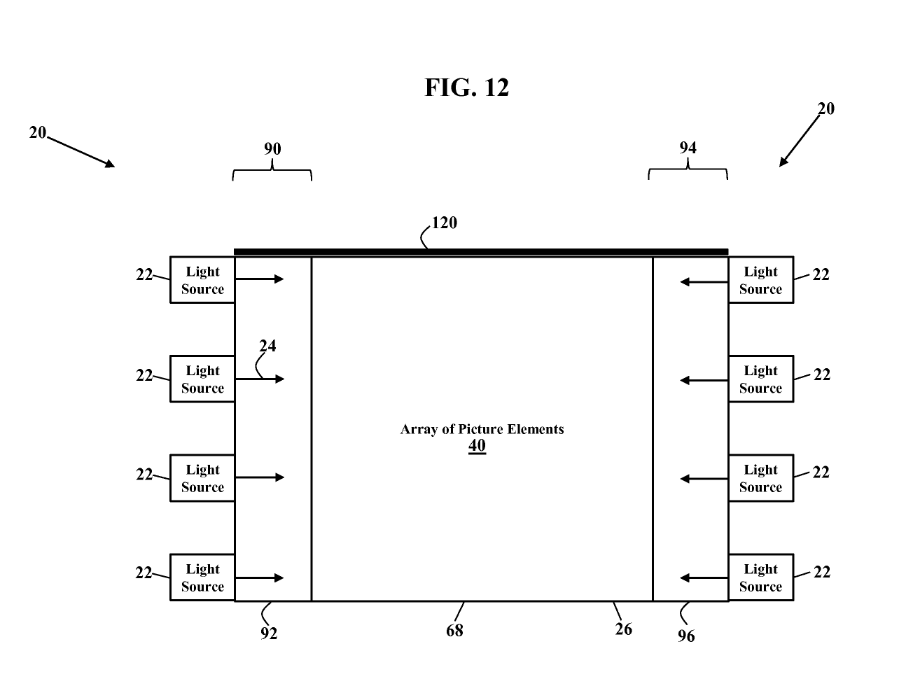

FIG. 12 is another top view of the illuminated display device 20, according to exemplary embodiments. Here the encasement feature 120 may be used to reflect the light 24 along any boundary edge or surface of the waveguide 26. The encasement feature 120 may be applied to or deposited onto any an inner or outer surface of the waveguide 26 to ensure the light 24 reflects with minimal or no refracting.

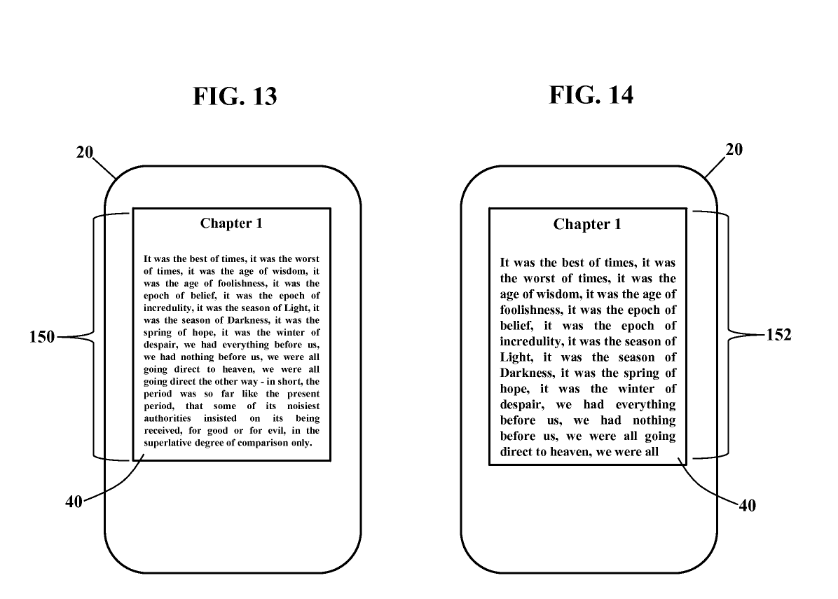

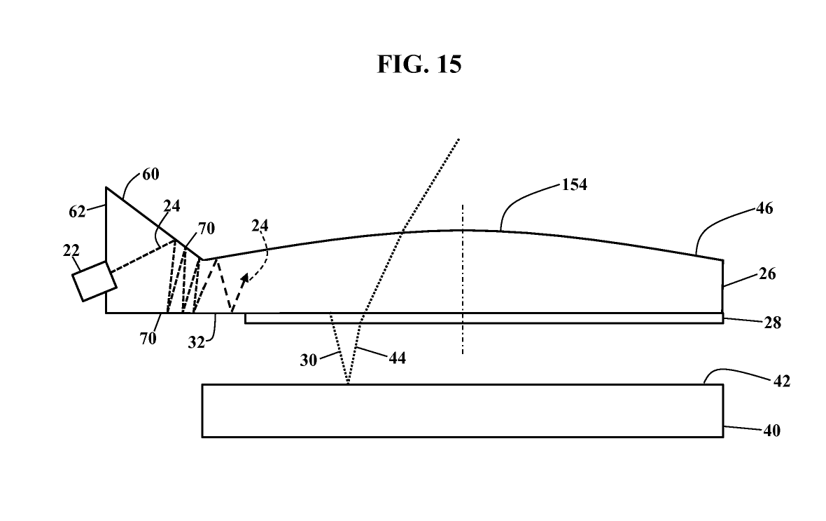

FIGS. 13-15 are schematics illustrating magnification, according to exemplary embodiments. FIGS. 13-14 are top views of the illuminated display device 20, while FIG. 15 is another sectional view. FIG. 13 illustrates an image or output 150 produced by the array 40 of picture elements, while FIG. 14 illustrates a magnified view 152 of that same image or output. Because exemplary embodiments may place the waveguide 26 between the array 40 of picture elements and the viewer's eye (as illustrated in FIGS. 1 and 2), exemplary embodiments may also magnify an output produced by the array 40 of picture elements. As FIG. 15 illustrates, the waveguide 26 may have features that optically magnify the image or output produced by the array 40 of picture elements. The top, outer surface 46 of the waveguide 26, for example, may have a convex cross-sectional contour 154, thus acting as a magnifying lens to enlarge an appearance of the image or output produced by the array 40 of picture elements. Magnification may be especially useful for cell phones, e-readers, and other devices with small displays. Exemplary embodiments, however, may also de-magnify (such as when the outer surface 46 of the waveguide 26 has a concave cross-sectional contour).

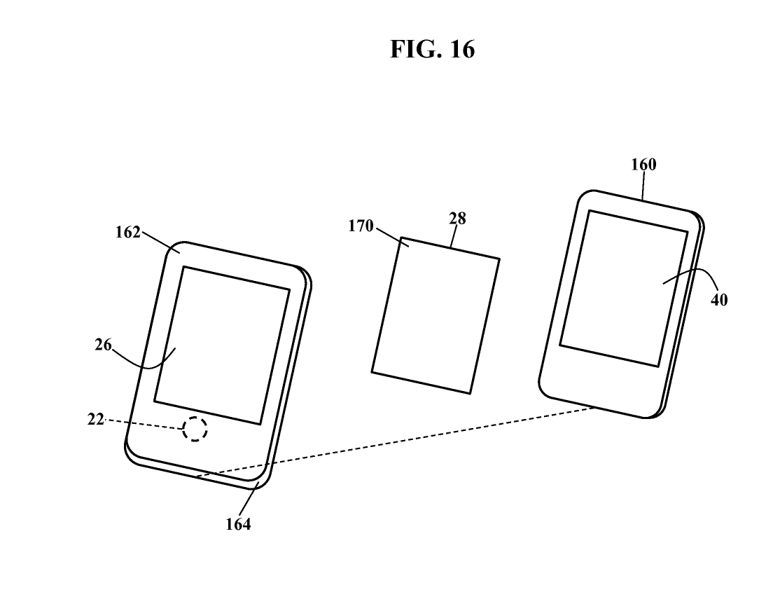

FIG. 16 is an exploded view of a computing device 160 incorporating the exemplary embodiments. The computing device 160 may be any laptop computer, tablet computer, or other processor controlled device. FIG. 16, though, illustrates the waveguide 26 having a snap-on configuration for mating to the computing device 160. The waveguide 26 is constructed to include an outer frame 162. The outer frame 162 may have a resilient, peripheral lip 164 that is sized to slip-on or snap over the computing device 160. The outer frame 162, for example, may be designed and sized to mate with an outer casing of any laptop computer, electronic reader (or “e-reader”), PDA or smart phone (such as the IPHONE® from APPLE®, Inc.), or tablet (such as the IPAD® from APPLE®, Inc.). The outer frame 162 may thus snap onto or over the computing device 160, thus arranging the waveguide 26 above the array 40 of picture elements of the computing device 160.

Frustration may thus be achieved. As many computing devices 160 include a thin-film screen protector 170, the screen protector 170 may double as the frustator 28. That is, when the outer frame 162 is snapped onto and/or over the computing device 160, the waveguide 26 is oriented near to or against the thin-film screen protector 170. The light source 22 within the outer frame 162 injects the light into the waveguide 26, and the thin-film screen protector 170 causes the frustrated light (illustrated as reference numeral 30 in FIGS. 1-5) to exit the waveguide 26 and to shine down onto the array 40 of picture elements of the computing device 160. The frustrated light 30 illuminates the array 40 of picture elements and reflects back through the waveguide 26 toward the viewer's eye 50.

FIG. 16 thus illustrates a clever snap-on device that illuminates the computing device 160. The outer frame 162 may be snapped on or overlaid onto the computing device 160 to illuminate the array 40 of picture elements. Exemplary embodiments may thus provide illumination of inexpensive electronic readers (such as the AMAZON® KINDLE®) that utilize electronic ink technology. The outer frame 162 may be sized to snuggly fit or snap over any computing device 160 to provide illumination.

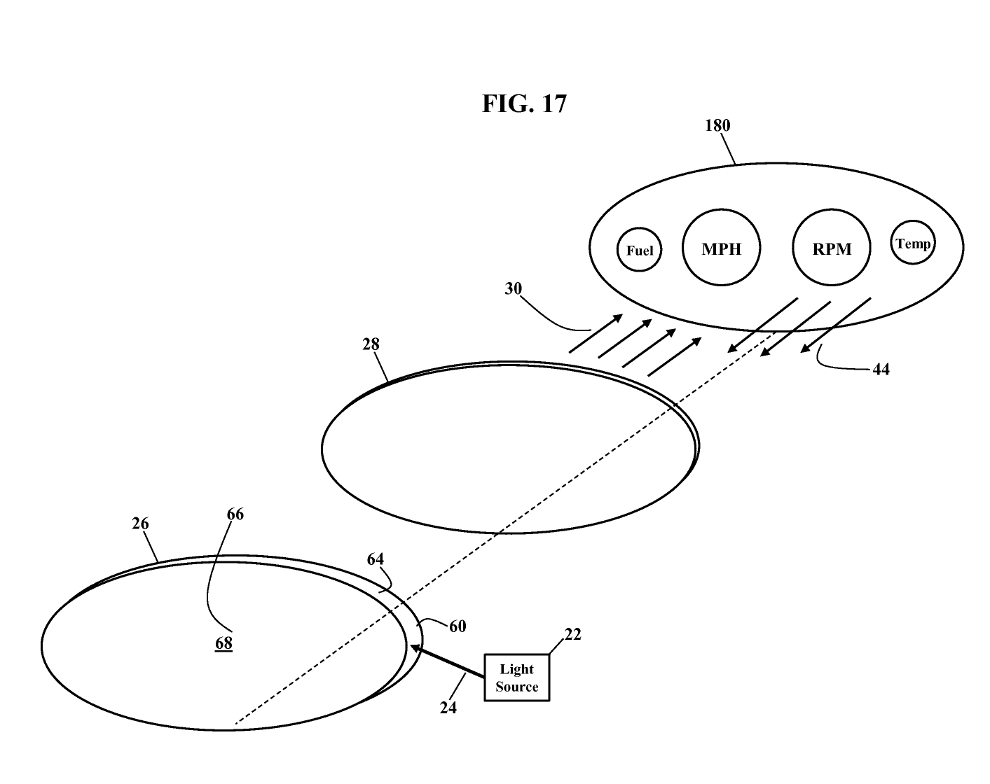

FIG. 17 is an exploded view of an instrument cluster 180 incorporating the exemplary embodiments. Most cars, trucks, and other vehicle have an instrument cluster providing speed, fuel level, and other driver information. Exemplary embodiments may be used to illuminate the instrument cluster 180 again using frustrated total internal reflection. The waveguide 26 is placed or arranged above the instrument cluster 180. The waveguide 26 includes the tapered cross-section 60, which may be configured as a circumferential or annular ring that tapers from the greater cross-sectional thickness T_{edge} (illustrated as reference numeral 64) to the cross-sectional thickness T_{cen} (illustrated as reference numeral 66) of the thinner central region 68 of the waveguide 26. The light 24 is injected into the tapered cross-section 60 and reflected to create total internal reflection within the central region 68 of the waveguide 26. The frustator 28 is added or applied between the instrument cluster 180 and the waveguide 26. The frustator 28 causes the frustated light 30 to illuminate a surface of the instrument cluster 180. The reflected light 44 propagates back through the waveguide 26 and travels to the driver's eye. Exemplary embodiments thus allow the instrument cluster 180 to be inexpensively illuminated from above, instead of from behind.

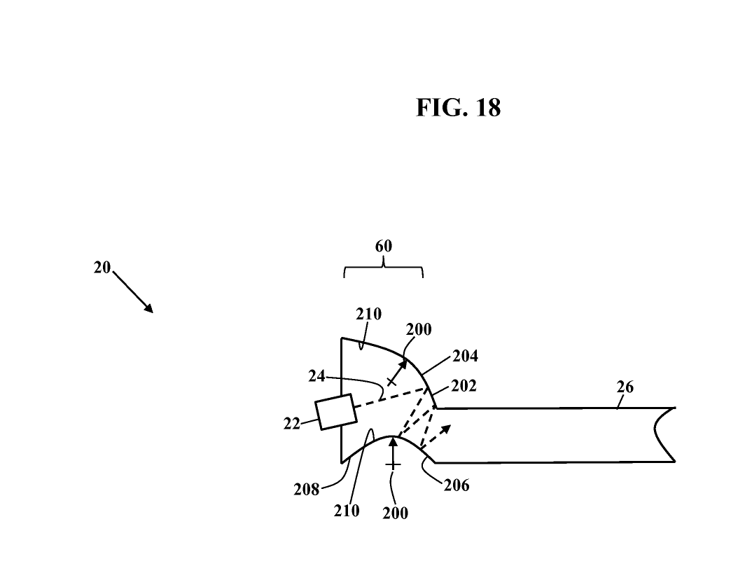

FIG. 18 is another partial sectional view illustrating the display device 20, according to exemplary embodiments. Here the tapered cross-section 60 (or reference numerals 90 and 94) may further include a radius 200 of curvature that helps obtain total internal reflection (or “TIR”) within the waveguide 26. The radius 200 of curvature may be molded, attached, or fabricated at any portion of the tapered cross-section 60. FIG. 18, for example, illustrates a side 202 having a convex curvature 204 that outwardly bows from the tapered cross-section 60. The radius 200 of curvature, however, may have a convex curvature 206. As FIG. 18 further illustrates, a bottom side 208 may inwardly bow within or into the tapered cross-section 60. One or more sides of the tapered cross-section 60 may include the radius 200 of curvature, and the radius 200 of curvature may be constant or vary along an arc length 210.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method, comprising:
injecting light into a tapered portion of a waveguide;
reflecting the light in the tapered portion to create total internal reflectance in the waveguide;
directing the light in a first direction onto an array of picture elements;
reflecting the light from the array of picture elements through the waveguide to create reflected light traveling in a second direction; and
controlling the array of picture elements to create an image,
wherein the reflected light presents to a viewer the image created by the array of picture elements.

2. The method according to claim 1, further comprising reflecting the light at an angled surface of the tapered portion of the waveguide.

3. The method according to claim 1, further comprising focusing the light into the tapered portion of the waveguide.

4. The method according to claim 1, wherein injecting the light comprises injecting the light from a light emitting diode.

5. The method according to claim 1, wherein injecting the incoming light comprises injecting visible light into the waveguide.

6. The method according to claim 1, further comprising applying a voltage to the array of picture elements.

7. The method according to claim 1, further comprising arranging the array of picture elements below the waveguide.

8. The method according to claim 1, further comprising arranging the array of picture elements behind the waveguide.

9. The method according to claim 1, further comprising arranging the waveguide between the array of picture elements and the viewer.

10. An apparatus, comprising:
an array of picture elements;
a waveguide above the array of picture elements, the waveguide having a tapered portion that receives injected light, the waveguide focusing the injected light in the tapered portion to create total internal reflectance in the waveguide; and
a frustrator withdrawing frustrated light onto the array of picture elements,
wherein the frustrated light illuminates an output produced by the array of picture elements.

11. The apparatus according to claim 10, further comprising a light source injecting the injected light into the tapered portion of the waveguide.

12. The apparatus according to claim 10, further comprising a reflective material on the tapered portion of the waveguide.

13. The apparatus according to claim 10, wherein the waveguide transmits reflected light from the array of picture elements.

14. The apparatus according to claim 10, wherein the frustrator comprises a coating that frustrates total internal reflectance of the injected light in the waveguide.

15. The apparatus according to claim 10, wherein the frustrator comprises a film that frustrates total internal reflectance of the injected light in the waveguide.

16. The apparatus according to claim 10, further comprising a circuit that applies a voltage to the array of picture elements.

17. The apparatus according to claim 10, further comprising a magnifier that optically magnifies the output produced by the array of picture elements.

18. An apparatus, comprising:
a waveguide having a tapered portion;
a source injecting light into the tapered portion of the waveguide, the tapered portion reflecting the light to create total internal reflectance in the waveguide;
a frustrator that extracts frustrated light from the waveguide; and
an array of picture elements reflecting the frustrated light back into the waveguide,
wherein the array of picture elements is illuminated from above by the frustrated light.

19. The apparatus according to claim 18, further comprising a reflective material on the tapered portion of the waveguide.

20. The apparatus according to claim 19, wherein the frustrator is at least one of a coating and a film applied to the waveguide.
